(19) United States
(12) Patent Application Publication
(10) Pub. No.: US 2008/0121510 A1
(43) Pub. Date: May 29, 2008

(54) SWITCHABLE BLOWER MOTOR RESISTOR FOR HVAC APPLICATION

(76) Inventors: Markus von Kruchten, Niederkassel (DE); Andrea Gentile, Euskirchen (DE)

Correspondence Address: FRASER CLEMENS MARTIN & MILLER LLC, 28366 KENSINGTON LANE, PERRYSBURG, OH, 43551, US

(21) Appl. No.: 11/685,256

(22) Filed: Mar. 13, 2007

(30) Foreign Application Priority Data
Mar. 13, 2006 (DE) 102006011766.2

(51) Int. Cl. H01H 15/02

(52) U.S. Cl. 200/572

(57) ABSTRACT

A low voltage range power switch is provided. The power switch includes a contact pin and at least two contact bushes. The contact pin has a longitudinal axis L and is arranged so as to be displaceable along a displacement path W in the direction of the longitudinal axis L. A graduated rotation speed adjuster having the power switch and a motor vehicle ventilation system including the graduated rotation speed adjuster are also provided.

### CROSS-REFERENCE TO RELATED APPLICATION

This application claims priority to German Patent Application Number 102006011766.2, filed Mar. 13, 2006, and German Patent Application Number 102006015502.5, filed Mar. 31, 2006, the entire disclosures of which are incorporated herein by reference.

### FIELD OF THE INVENTION

The present disclosure relates to power switches, and more particularly, to power switches and rotation speed adjusters adapted for use with low voltage electric motors.

### BACKGROUND OF THE INVENTION

The current trend in the development of motor vehicles is towards motor vehicles equipped with electronics to an increasing extent. A far-reaching electrification of the motor vehicle has taken place, by which a broad use of control electronics—increasingly of a digital basis—is now commonplace. Notwithstanding this trend, however, there is a large market for simply equipped motor vehicles in the “low cost” range, in which the use of expensive electronic circuits is deliberately avoided to optimize vehicle cost.

An example of this is the ventilation and air-conditioning technology of modern motor vehicles. Air-conditioning installations of modular construction and digital control have been employed in the field of small cars, permitting in part a separate air-conditioning of various spatial zones of a motor vehicle. Large numbers of motor vehicles are still supplied without an air-conditioning installation, however. In such motor vehicles, the spatial climate in the interior is brought about by simple fan arrangements. The simple fan arrangements are typically controlled manually by the user of the motor vehicle, and blow in air. The air is typically regulated with respect to temperature, and is blown in at various locations in the interior of the motor vehicle. Generally, axial fans which are driven by an electric motor are used to blow in the air. The electric motors which are used are designed for operation on the low voltage power supply of the motor vehicle.

As is known in the art, a simple rotation speed control and various fan stages is often realized by means of graduated voltage dividers, in which the voltage drop along a chain of power resistances connected in series is utilized. A high current-proof, multi-stage (rotary) switch for controlling rotation speed is generally arranged on the instrument panel of the motor vehicle. A user can selectively bring the fan motor in connection with various pick-off points of the voltage divider. The fan motor is thereby acted upon with various operating voltages, from which various rotation speed stages may result.

The ohmic resistances necessary to realize a corresponding voltage divider are frequently realized in the form of metallic resistance wire wound on a ceramic holder. Corresponding resistance elements may consist of several power resistances on a ceramic holder connected in series. The resistance elements may be optimized particularly for use in the motor vehicle field and are commercially available, for example, from KRAH-RWI Elektronische Bauelemente GmbH, 57389 Drolshagen, Germany.

With an operating voltage of about 12V, which is typical for motor vehicles, the high current-proof, low voltage rotary switches used in the art have a maximum current carrying capacity of 20 to 30 Ampere. The maximum current carrying capacity of 20 to 30 Ampere limits the power absorption of a connected electrical consumer to relatively low values, which may be a disadvantage in individual cases. The connected electrical consumer may be, in particular examples, a low voltage electric motor. High current-proof rotary switches are also relatively complicated and costly to construct.

As the use of voltage dividers automatically leads to the occurrence of high power losses in the ohmic resistances typically used, an effective cooling of the resistance elements is desirable. For this purpose, the resistance elements in motor vehicles are generally not arranged in the region of the instrument panel in the immediate vicinity of the multi-stage rotary switch, but rather are arranged inside the interior fan arrangement of the motor vehicle in such a way that they have a cooling stream of air flowing around them when the fan arrangement is in operation.

The arrangement of the resistance elements adjacent the cooling stream of air avoids the use of costly active cooling measures. The arrangement also requires that a plurality of electrical connecting lines capable of high current be laid between the multi-stage rotary switch arranged in the instrument panel and the resistance element consisting of several resistance elements connected in series. Owing to the high working currents occurring in the operation of the electric fan motor, the plurality of electrical connecting lines are necessarily equipped with large cable cross-sections. Nevertheless, in the practical use of the motor vehicle, particularly at high ambient temperatures, problems occur with line failures due to thermal overload of the electrical connecting lines. Furthermore, the long line paths unavoidably involve additional line losses which can have a negative effect on the performance of the installation.

Finally, the current carrying capacity of conventional low voltage power switches is limited. Previously known power switches are also subject to ageing. Ageing allows the transfer resistances at the switching contacts to grow over the course of time. Also, in a power switch of the previously known type, thermal problems can occur at raised temperatures, and may lead to a failure of the power switch.

There is a continuing need for a low voltage range power switch having an improved current carrying capacity and a simplified construction. A graduated rotation speed adjuster which can also be used for low voltage electric motors having increased power consumption is also desired. In particular, the desired graduated rotation speed adjuster for a low voltage electric motor of a motor vehicle ventilation system can be operated in a failsafe manner at raised ambient temperatures.

### SUMMARY OF THE INVENTION

In concordance with the instant disclosure, a low voltage range power switch having an optimized current carrying capacity and a simplified construction, and a graduated rotation speed adjuster that can also be used for low voltage electric motors having increased power consumption that can be operated in a failsafe manner at raised ambient temperatures, is surprisingly discovered.

The subject matter of the present invention is a low voltage range power switch and a graduated rotation speed adjuster for a low voltage electric motor. The power switch and the rotation speed adjuster are able to be used, in particular, for a fan motor of a motor vehicle. It should be understood that the following description relates primarily to this case of application, but the power switch and the graduated rotation speed adjuster according to the invention are also able to be used in other technical fields as desired.

In one embodiment, a power switch for the low voltage range has a contact pin and at least two contact bushes. The contact pin has a longitudinal axis L and is arranged displaceably along a displacement path W in the direction of the contact pin's longitudinal axis L. The contact bushes are constructed to hold the contact pin and form a high current-proof electrical contact. In addition, the contact bushes are arranged one behind the other along the displacement path W.

In a further embodiment, an electrical connection is produced between two contact points when the contact pin is inserted into adjacent contact bushes. Electric lines may thereby be connected with each other.

In contrast to the otherwise widespread rotary switches, an electrical contact is not produced between a contact surface and a slider which is actuated by means of rotary knob. Rather, in the present invention, an electrical contact is produced between a contact pin and two contact bushes, which can be acted upon by distinctly higher currents than the electrical contact between a contact surface and slider forming in the case of the rotary switch, owing to the fact that the contact bushes surround the contact pin on all sides.

In another embodiment, the power switch according to the invention has the advantage that, in an application for a graduated rotation speed adjuster for a ventilation arrangement in a motor vehicle, the power switch can be arranged adjacent a multi-stage resistance element. The actuation of the power switch by means of an actuating element arranged in the instrument panel of the motor vehicle is possible in the simplest manner by providing a Bowden cable that, originating from the instrument panel, transfers a translational or rotational movement to the power switch. A translational movement of the contact switch is brought about on the power switch of the disclosure by means of the transferred translational or rotational movement. In this way, it is possible to substantially omit long electrical connecting lines, which are typical in the rotation speed adjusters known in the art, between a rotary switch arranged on the instrument panel and a multi-stage resistance element arranged on the underside of the motor vehicle.

In the described arrangement, only very short electrical connecting lines are produced between the power switch of the disclosure and a multi-stage resistance element which is to be connected thereto, so that even at raised operating temperatures a power switch according to the invention with a connected multi-stage resistance element always has a sufficient current carrying capacity. The power switch of the disclosure has a sufficient current carrying capacity for continuous operation.

Particular advantages are produced when the contact pin of the power switch according to the invention has a copper-bearing core, which is provided on its surface with a corrosion-resistant, abrasion-proof conducting coating. A plurality of suitable conducting coatings is known in the art. As a nonlimiting example, the conducting coating may include one or more metallic alloys.

Further advantages are produced if at least one contact bush of the power switch according to the invention, but advantageously all the contact bushes, have an enclosed hyperbolic contact grid which is provided to receive the contact pin, forming a plurality of line contacts in it. Corresponding contact bushes are sold for example by the German company Amphenol-Tuchel Electronics GmbH, D-74080 Heilbronn under the brand “Radsok®”. Amphenol-Tuchel Electronics GmbH is a subsidiary company of the US company Amphenol-Tuchel, located in Canton, Mich. 48187, USA. Particular advantages are produced if the internal hyperbolic contact grid has a core of a beryllium/copper alloy, for example.

Details of the structure and the production of contact bushes have been described in a number of national and international published applications, for example, WO 03/032450 A1, WO 03/044901 and WO 00/70713, the entire disclosures of which are incorporated herein by reference.

The power switch according to the invention can be actuated, for example, by means of a manually actuated mechanical drive, in which the mechanical drive displaces the contact pin along the displacement path W. The mechanical drive here may be constructed as a Bowden cable for example, which is suitable for the transfer of a rotational or translational movement. The Bowden cable is connected at its first end in a suitable manner to the power switch according to the invention, and at its second end with an actuating element which is arranged in the instrument panel of the motor vehicle. When the actuating element is actuated, a translational or rotational movement of the Bowden cable is then brought about, which is transferred to the power switch. On the power switch itself, the movement of the Bowden cable is converted by means of a suitable transformation gear into a translational movement which actuates the contact pin of the power switch according to the invention.

Alternatively, the power switch can also be constructed so that the contact pin is displaceable along the displacement path W by means of a drive which is actuated by a motor. In this case, a simple control arrangement is provided in the instrument panel of the motor vehicle for the motor drive of the power switch.

In a further embodiment, a graduated rotation speed adjuster for a low voltage electric motor is now realized by means of a power switch according to the invention. Such a graduated rotation speed adjuster comprises an at least three-stage power switch and at least one power resistance.

In an advantageous development, such a graduated rotation speed adjuster has three switching stages for an electric motor which is connected to an external voltage source via the rotation speed adjuster. These three switching stages include: a) interrupted connection with the voltage source; b) direct connection with the voltage source; and c) connection with the voltage source via the power resistance, which is connected in series.

In this way, three operating states of the connected low voltage electric motor, for example, the fan motor, can be realized, namely: a) off; b) fast; and c) slow.

The number of power stages of a graduated rotation speed adjuster according to the invention can be readily expanded, in which a power switch having more switching stages and accordingly a greater number of power resistances is provided. Particular advantages are produced when the power resistance is formed by a metallic resistance wire which is wound around an insulating base body and is coated with an insulation layer. For example, a tube or a flat material of a ceramic material come into consideration here as an insulating base body.

In an additional embodiment, a motor vehicle ventilation system is described. The motor vehicle ventilation system includes a low voltage electric motor adapted to power a fan, and a graduated rotation speed adjuster. The graduated rotation speed adjusted includes an at least three-stage power switch for the low voltage range and at least one power resistance. The power switch includes a contact pin and at least two contact bushes, The contact bushes are adapted to receive the contact pin and form a high current-proof electrical contact.

### DRAWINGS

The above, as well as other advantages of the present disclosure, will become readily apparent to those skilled in the art from the following detailed description, particularly when considered in the light of the drawings described herein.

FIG. 1 shows a schematic illustration of a graduated rotation speed adjuster of the prior art, using a conventional power rotary switch and several power resistances; and

FIG. 2 shows a schematic illustration of a graduated rotation rate adjuster, including a power switch according to the invention and several power resistances.

### DETAILED DESCRIPTION OF THE INVENTION

The following description is merely exemplary in nature and is not intended to limit the present disclosure, application, or uses. It should also be understood that throughout the drawings, corresponding reference numerals indicate like or corresponding parts and features. In respect of the methods disclosed, the steps presented are exemplary in nature, and thus, are not necessary or critical.

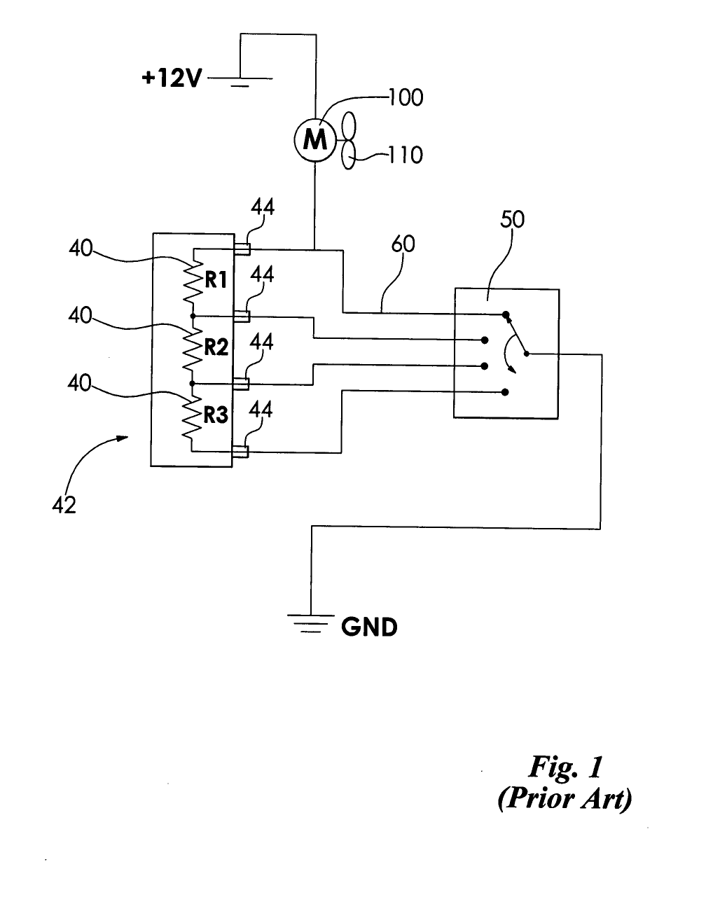

FIG. 1 shows a graduated rotation speed adjuster for a low voltage electric motor of the prior art, as is used for example for a ventilation fan of a motor vehicle. Three power resistances 40 (R1, R2 and R3) are formed from a metallic resistance wire and are wound on a shared ceramic carrier, for example. The power resistances 40 are connected in series with each other, and connecting bushes 44 are disposed at the respective connecting points for the connection of external connecting lines 60. The metallic resistance wires which are wound on the ceramic body are cast with an insulating layer. A multi-stage resistance element 42 is thereby produced which is substantially maintenance-free and is able to be loaded mechanically.

The multi-stage resistance element 42 is connected in series with a low voltage electric motor 100. One or more of the power resistances 40 contained in the resistance element 42 are connected in series with the low voltage electric motor 100 via a power rotary switch 50.

A typical example of use for the graduated rotation speed adjuster which is shown is the ventilation fan of a motor vehicle, which can be switched into several power stages by means of the rotary switch 50 which is arranged on the instrument panel of the motor vehicle.

The multi-stage resistance element 42 is typically disposed inside the interior fan arrangement of the motor vehicle so that when the fan arrangement is in operation the resistance element 42 has a cooling stream of air flowing around the resistance element 42 substantially constantly. The low voltage electric motor 100, which serves to drive the axial fan, is disposed inside the interior fan arrangement. A skilled artisan should appreciate that the interior fan arrangement is generally arranged at a suitable location in the engine compartment.

The multi-stage power rotary switch 50 is arranged on an instrument panel, for example. A plurality of electrical connecting lines 60 are disposed between the multi-stage resistance element 42 and the power rotary switch 50. It should be understood that the connecting lines 60 are generally formed in the automotive industry as copper lines having a line cross-sectional area of approximately 4 mm².

The graduated rotation speed adjuster which is shown in FIG. 1 for a low voltage electric motor for ventilating the interior of a motor vehicle have known disadvantages. First, there is a high thermal load of the connecting lines 60 owing to the high currents which occur when the fan motor 100 is in operation. Second, there are relatively high voltage drops along the long electrical connecting lines 60. Third, the current-proof characteristic of a low voltage power rotary switch 50 is limited, due to the type of construction, to currents in the range of typically 25 amperes.

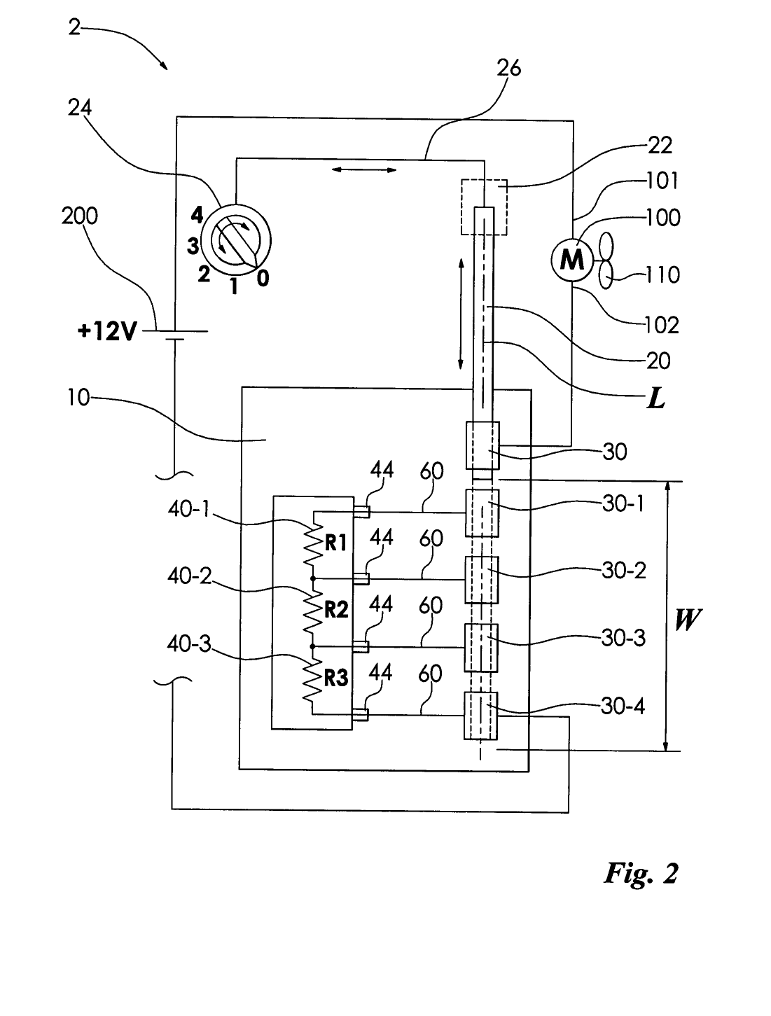

Referring now to FIG. 2, a graduated rotation speed adjuster 2 according to the present invention is shown. The graduated rotation speed adjuster 2 includes a power switch 10 according to the invention. The graduated rotation speed adjuster 2 which is shown is discussed by way of example, having a fan arrangement for the interior ventilation of a motor vehicle (not shown).

The fan arrangement comprises an external voltage source 200, for example a battery of the motor vehicle, one pole of which is grounded and the other pole of which is connected with a first connection 101 of a low voltage electric motor 100. A fan wheel 110 is arranged on the low voltage electric motor 100, in order to draw in ambient air and to convey it into the interior of the motor vehicle after a temperature conditioning.

The graduated rotation speed adjuster 2 according to the invention is used to create various power stages of the fan arrangement. For example, a first connection (not shown) of a power switch 10 according to the invention is connected with the motor vehicle mass, and a second connection (not shown) is connected with the second connection 102 of the low voltage electric motor 100.

The power switch 10 includes about five cylindrical contact bushes 30 to 30-4, in which the axes of symmetry of the contact bushes 30 are arranged colinearly. An electrically conductive cylindrical contact pin 20 is inserted into a first contact bush 30, with a longitudinal axis L of the first contact bush 30 coinciding with the axes of symmetry of the contact bushes 30. The dimensions of the cylindrical contact pin 20 are now such that the contact pin 30 can be displaced from the position shown in FIG. 2, in which the contact pin 20 is only in engagement with the contact bush 30, towards the further contact bushes 30-1 to 30-4. With a displacement along the displacement path W, the contact pin 20 successively arrives in engagement with the further contact bushes 30-1, 30-2, 30-3 and finally 30-4.

In one embodiment, the longitudinal axis of the contact pin 20 is a straight line. Equally the displacement path W of the contact pin 20 through the contact bushes 30 to 30-4 is likewise a straight line. However, the invention is not restricted to this: for example, a curved contact pin 20 may be employed as desired, which is then displaced along a curved displacement path W through the plurality of contact bushes 30.

In a further embodiment, a power resistance 40-1 to 40-3 is arranged respectively between the contact bushes 30-1 and 30-2, 30-2 and 30-3 and 30-3 and 30-4, for example. These power resistances 40 are part of a resistance element 42, in which individual power resistances 40 are wound onto a shared ceramic carrier and are cast in an electrically insulating manner with the ceramic base body, for example. The individual power resistances 40 may be constructed as sections of a metallic resistance wire. However, one of ordinary skill understands that other suitable types of construction of power resistances are also known in the art, e.g. film resistances.

Four connecting bushes 44 are formed on the resistance element 42. As can be seen from FIG. 2, the power resistances 40-1 to 40-3 are connected internally with each other and with the connecting bushes 44. As a nonlimiting example, the resistance element 42 is connected with the contact bushes 30 to 30-4 so that the contact bushes 30 to 30-4, which are adjacent to each other, are respectively connected electrically with each other via the power resistances 40-1 to 40-3. Preferably, the contact bushes 30 to 30-4 and the resistance element 42 are connected with each other mechanically and electrically here so that a one-piece component is produced. Separate connecting lines are not necessary between the contact bushes 30 to 30-4 and the power resistances 40-1 to 40-3. Thus, it should be appreciated that the overall size can be optimized, with the number of components to be constructed being able to be minimized.

With respect to the contact pin 20, the second connection 102 of the low voltage electric motor 100 is separate from the vehicle mass. The low voltage electric motor 100 is at a fixed position in the motor vehicle. When the contact pin 20 is displaced from a “zero position” shown in FIG. 2 along the displacement path W towards the first contact bush 30-1, the contact pin 20 engages with the first contact bush 30-1. The second connection 102 of the low voltage electric motor 100 is then connected with the vehicle mass via the series connection of the power resistances 40-1, 40-2 and 40-3. The low voltage electric motor 100 is thereby acted upon with a low operating voltage. This state corresponds to a lowest rotation speed setting of the graduated rotation speed adjuster 2 according to the invention.

When the contact pin 20 is pushed further in the manner described above along the displacement path W into the second contact bush 30-2, an electrical contact is produced between the contact bush 30 and the second contact bush 30-2. The second connection 102 of the low voltage electric motor 100 is then only connected via the two power resistances 40-2 and 40-3 with the vehicle mass (the power resistance 40-1 is bridged). The low voltage electric motor 100 is thereby acted upon with a greater operating voltage. In this state, a second rotation speed stage is realized.

Finally, if the contact pin 20 is moved along the displacement path W so that an electrical contact is produced between the contact bush 30 and the fourth contact bush 30-4, then all the power resistances 40-1 to 40-3 are bridged. The low voltage electric motor 100 is thereby directly connected with both poles at the external voltage source 200. A highest rotation speed stage of the graduated rotation speed adjuster 2 for a low voltage electric motor 100 is realized.

A skilled artisan should understand that the graduated rotation speed adjuster 2 according to the invention can be readily expanded to any desired number of rotation speed stages. As a nonlimiting example, the three rotation speeds such as “off,” “moderate rotation speed,” and “high rotation speed” can be realized by only three contact bushes 30 to 30-2 and a power resistance 40-1 being provided.

Alternatively, the contact pin 20 may also be constructed as a straight or coiled hollow element, e.g., as a copper tube which is coated with a wear-resistant coating. Tubular contact pins 20 may additionally have special thermal advantages, because they can be force-cooled in a simple manner. It should be recognized that other suitable contact pin 20 designs may be used as desired.

In one embodiment shown in FIG. 2, the resistance element 42 is arranged directly on the power switch 10, so that a length of the connecting lines 60 running between the connecting bushes 44.1 to 44.4 to the contact bushes 30-1 to 30-4 may be optimized. For example, the length of the connecting lines 60 may be substantially shortened. Through this, problems of overheating of the connecting lines 60 are reliably militated against, even at the highest operating temperatures. Increased voltage losses along the connecting lines 60 likewise are substantially reduced. These advantages can be realized, although the resistance element 42 is also arranged on the underside of the motor vehicle, so that the resistance element 42 has a cooling stream of air flowing around it substantially constantly when the motor vehicle is in operation.

The power switch (10) can be actuated from the instrument panel of the motor vehicle (not shown) by means of an actuating element 24 which is connected with the power switch 10 via a Bowden cable 26. The Bowden cable 26 is provided to transfer a translational or rotational movement from an actuating element 24 to the power switch 10. In this way, extended electrical connecting lines 60 between the instrument panel and the resistance element 42, as are usual in the prior art, are superfluous.

In another embodiment, the actuating element 24 is constructed as a rotary knob with an integral movement converter. A rotational movement of the rotary knob is converted directly into a translational movement of the Bowden cable 26, which is further connected to a movement converter. An end of the Bowden cable 26 can therefore be connected with the contact pin 20 of the power switch 10. Alternatively, a mechanical drive 22 may be provided on the power switch 10, said mechanical drive 22 being adapted to convert a rotational movement of the Bowden cable 26 into a translational movement for a linear drive of the contact pin 20, for example. The mechanical drive 22 can also be constructed as a transmission gear by which a high amplitude translational movement of the Bowden cable 26 is converted into a low amplitude translational movement to drive the contact pin 20.

It should be further understood that detent stages may be provided on the actuating element 24, which coincide with contact positions of the contact pin 20 in the various contact bushes 30 as described herein. Thus, the operating comfort of the rotary knob may be further optimized.

In other applications, the actuating element 24 can also be arranged directly on the power switch 10, in order to realize a comparable operability to the rotary switches known in the art.

In the example embodiment shown, the contact bushes 30 are realized by means of the contact bushes of the type described in the introduction, sold under the brand “Radsok ®”, as sold by the US American company KonneKtech Ltd. However, the invention is not restricted to the use of such contact bushes. Instead, any contact bush providing a high current-proof electrical connection between an electrically conductive contact pin 20 and a contact bush 30 may be employed, in so far as the contact bush has sufficient current carrying capacity for the desired application.

The power switch for the low voltage range according to the invention and also the graduated rotation speed adjuster 2 for a low voltage electric motor according to the invention were illustrated above using the example of a graduated rotation speed adjuster 2 for a fan of a motor vehicle ventilation system. One of ordinary skill in the art should understand, however, that neither the rotation speed adjuster 2 according to the invention nor the power switch 10 according to the invention are limited to this usage.

While certain representative embodiments and details have been shown for purposes of illustrating the invention, it will be apparent to those skilled in the art that various changes may be made without departing from the scope of the disclosure, which is further described in the following appended claims.

1.-11. (canceled)

12. A low voltage range power switch, comprising:
a contact pin; and
at least two contact bushes;
wherein the contact bushes are adapted to receive the contact pin and form a high current-proof electrical contact.

13. The power switch of claim 12, wherein the contact pin has a longitudinal axis L and is displaceable along a displacement path W in the direction of the contact pin's longitudinal axis L.

14. The power switch of claim 12, wherein the contact bushes are disposed in a sequence along the displacement path W.

15. The power switch according to claim 12, wherein the contact pin has a copper-bearing core.

16. The power switch according to claim 12, wherein the contact pin has a substantially corrosion-resistant and abrasion-proof conductive coating deposited thereon.

17. The power switch according to claim 12, wherein the contact bush has a hyperbolic contact grid disposed in an interior of the contact bush.

18. The power switch of claim 17, wherein the hyperbolic contact grid is adapted to receive the contact pin and form a plurality of line contacts.

19. The power switch according to claim 17, wherein the hyperbolic contact grid has a core formed of a beryllium/copper alloy.

20. The power switch according to claim 13, wherein the contact pin is displaceable along the path W a manually actuated mechanical drive.

21. The power switch according to claim 12, further comprising an actuating element adapted for manual actuation.

22. The power switch according to claim 21, wherein the actuating element is in operative connection with a mechanical drive adapted to displace the contact pin.

23. The power switch according to claim 12, wherein the contact pin is displaceable by means of a mechanical drive operable by a motor.

24. A graduated rotation speed adjuster for a low voltage electric motor, comprising:
a low voltage range power switch, including a contact pin, and at least two contact bushes, wherein the contact bushes are adapted to receive the contact pin and form a high current-proof electrical contact; and
at least one power resistance.

25. The graduated rotation speed adjuster of claim 24, wherein the power switch has at least three stages.

26. The graduated rotation speed adjuster according to claim 24, wherein the rotation speed adjuster has three switching states for the electric motor in electrical communication with an external voltage source via the rotation speed adjuster.

27. The graduated rotation speed adjuster of claim 26, wherein the three switching states include: a) an interrupted connection to the voltage source; b) a direct connection with the voltage source; and c) a connection with the voltage source via the power resistance connected in series.

28. The graduated rotation speed adjuster according to claim 24, wherein the power resistance includes a metallic resistance wire wound around an insulating base body and coated with an insulating layer.

29. A motor vehicle ventilation system, comprising:
a low voltage electric motor adapted to power a fan; and
a graduated rotation speed adjuster, including an at least three-stage, low voltage range power switch and at least one power resistance, the power switch including a contact pin and at least two contact bushes, wherein the contact bushes are adapted to receive the contact pin and form a high current-proof electrical contact.

30. The motor vehicle ventilation system of claim 29, wherein the at least three-stage power switch and the at least one power resistance are disposed adjacent to each other and are in a heat exchange relationship with a stream of a cooling medium adapted to remove waste heat from the power resistance when the motor vehicle ventilation system is in operation.

31. The motor vehicle ventilation system of claim 29, further including a drive for the contact pin, wherein the drive is actuated by an actuating element disposed on the instrument panel of a motor vehicle.
